(19) United States
(12) Patent Application Publication
(10) Pub. No.: US 2008/0004200 A1
(43) Pub. Date: Jan. 3, 2008

(54) Enzyme stabilization

(76) Inventors: Jean-Pol Boutique, Gembloux (BE); Garry Steven Garrett, Fairfield, OH (US); Charles Winston Saunders, Fairfield, OH (US); Andre Cesar Baeck, Bonheiden (BE); Nathalie Jean Marie-Louise Vanwyngaerden, Leuven (BE); Thomas Edward Ward, Oregonia, OH (US); Eva Schneiderman, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/810,280

(22) Filed: Jun. 5, 2007

Related U.S. Application Data
(60) Provisional application No. 60/810,912, filed on Jun. 5, 2006.

(51) Int. Cl. C11D 7/42

(52) U.S. Cl. 510/393

(57) ABSTRACT

Liquid detergent compositions comprising a tripeptide enzyme inhibitors are provided. Methods of using the tripeptide enzyme inhibitor to stabilize liquid detergent compositions are also provided. Also provided are liquid detergent compositions wherein the tripeptide enzyme inhibitor at least inhibits the growth of at least one microbiological flora or fauna in the liquid detergent composition.

### CROSS REFERENCE TO RELATED APPLICATION

This application claims the benefit of U.S. Provisional Application Ser. No. 60/810,912, filed Jun. 5, 2006.

### FIELD OF THE INVENTION

The present invention is directed to enzyme stabilization systems as well as methods of using and compositions containing the same.

### BACKGROUND OF THE INVENTION

Protease-containing liquid compositions are well-known, especially in the context of laundry washing. A commonly encountered problem in such protease-containing liquid compositions is the degradation phenomenon by protease enzyme of second enzymes in the composition, such as amylase, lipase and cellulase, or on the protease itself. As a result, the stability of the second enzyme or the protease itself in the liquid composition is affected and the composition consequently performs less well.

In response to this problem, it has been proposed to use various protease inhibitors or stabilizers. For instance, references have proposed the use of compounds, such as the following to aid in the stabilization of enzymes: benzamidine hydrochloride, lower aliphatic alcohols or carboxylic acids, certain peptide aldehydes, mixtures of polyol solvents and boron compounds, magnesium and/or calcium salts (such as calcium formate).

Although these compounds have been used to varying success in liquid compositions, they are not free of problems. For example, they can be rather expensive and/or create complexities for the formulators, especially for liquid detergents. Other inhibitors or stabilizers are less expensive to use but do not stabilize enzymes sufficiently. Thus the need remains for a protease inhibitor which is economical, effective and suitable for use in a liquid composition, such as, a liquid laundry composition.

### SUMMARY OF THE INVENTION

One aspect of the invention relates to a liquid detergent composition comprising:
(a) a surfactant;
(b) a protease enzyme;
(c) a reversible peptide protease inhibitor, wherein the reversible peptide protease inhibitor is a tripeptide enzyme inhibitor;
(d) an adjunct ingredient;
   wherein the liquid detergent composition further comprises at least one of:
   (i) the reversible peptide protease inhibitor has an affinity constant for the protease enzyme of from about 50 nM to about 2 uM; and/or
   (ii) a molar ratio of the reversible peptide protease inhibitor to the protease enzyme of from about 1:1 to about 20:1.

Another aspect of the invention relates to a method of stabilizing enzymes in a liquid detergent composition, wherein the liquid detergent composition comprises one or more protease enzymes and wherein the method comprises at least the step of adding a stabilizing effective amount of a reversible peptide protease inhibitor to the liquid detergent composition, wherein the reversible peptide protease inhibitor has the formula:

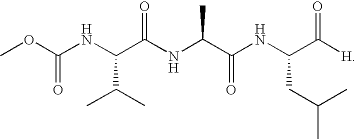

Another aspect of the invention relates to liquid detergent composition comprising:
(a) a surfactant;
(b) a protease enzyme;
(c) a reversible peptide protease inhibitor, wherein the reversible peptide protease inhibitor is a tripeptide enzyme inhibitor; and
(d) an adjunct ingredient;
   wherein the reversible peptide protease inhibitor at least inhibits the growth of at least one microbiological flora or fauna in the liquid detergent.

### DETAILED DESCRIPTION OF THE INVENTION

Definitions—As used herein, “liquid detergent composition” refers to any laundry treatment composition which are not in solid (i.e., tablet or granule) or gas form. Examples of liquid laundry detergent compositions include heavy-duty liquid laundry detergents for use in the wash cycle of automatic washing-machines, liquid finewash and liquid color care detergents such as those suitable for washing delicate garments, e.g., those made of silk or wool, either by hand or in the wash cycle of automatic washing-machines. The corresponding compositions having flowable yet stiffer consistency, known as gels, are likewise encompassed. Other liquid or gel-form laundry treatment compositions encompassed herein include dilutable concentrates of the foregoing compositions, unit dose, spray, pretreatment (including stiff gel stick) and rinse laundry treatment compositions, or other packaged forms of such compositions, for example those sold in single or dual-compartment bottles, tubs, or polyvinyl alcohol sachets and the like. The compositions herein suitably have a sufficiently fluid rheology that they may be dosed either by the consumer, or by automated dosing systems controlled by domestic or commercial laundry appliances. Stiff gel forms may be used as pretreaters or boosters, see for example US20040102346A1, or may be dispensed in automatic dispensing systems, for example through being dissolved in-situ in the presence of a stream of water.

In general, the compositions herein may be isotropic or non-isotropic. However, they do not generally split into separate layers such as phase split detergents described in the art. One illustrative composition is non-isotropic and on storage is either (i) free from splitting into two layers or, (ii) if the composition splits into layers, a single major layer is present and comprises at least about 90% by weight, more specifically more than about 95%, even more specifically more than about 99% of the composition. Other illustrative compositions are fully isotropic.

“Gel” as used herein includes a shear thinning gel with a pouring viscosity in the range of from 1,000 to 5,000 mPas (milli Pascal seconds), more specifically less than 3,000 mPas, even more specifically less than 1,500 mPas. Gels include thick liquids. More specifically, a thick liquid may be a Newtonian fluid, which does not change its viscosity with the change in flow condition, such as honey or syrup. This type of thick liquid is very difficult and messy to dispense. A different type of liquid gel is shear-thinning, i.e. it is thick under low shear (e.g., at rest) and thin at high flow rates. The rheology of shear-thinning gels is described in more detail in the literature, see for example WO04027010A1 Unilever.

Other illustrative compositions according to the present invention are pourable gels specifically having a viscosity of at least 1,500 mPa·s but no more than 6,000 mPa·s, more specifically no more than 4,000 mPa·s, even more specifically no more than 3,000 mPa·s and even more specifically still no more than 2,000 mPa·s.

Yet other illustrative compositions according to the present invention are non-pourable gels specifically having a viscosity of at least 6,000 mPa·s but no more than 12,000 mPa·s, more specifically no more than 10,000 mPa·s, even more specifically no more than 8,000 mPa·s and even more specifically still no more than 7,000 mPa·s.

Illustrative specific liquid or gel form laundry treatment compositions herein include heavy-duty liquid laundry detergents for use in the wash cycle of automatic washing-machines and liquid finewash and/or color care detergents. These suitably have the following rheological characteristics: viscosity of no more than 1,500 mPa·s, more specifically no more than 1,000 mPa·s, still more specifically, no more than 500 mPa·s. In one embodiment, these compositions have a viscosity of from 30 to 400 mPas and are either Newtonian or shear-thinning. In these definitions and unless specifically indicated to the contrary, all stated viscosities are those measured at a shear rate of 21 s⁻¹ and at a temperature of 25° C. Viscosity herein can be measured with any suitable instrument, e.g., a Carrimed CSL2 Rheometer at a shear rate of 21 sec⁻¹.

Reversible peptide protease inhibitor—The stabilizing enzymes of the present invention comprise a reversible peptide protease inhibitor wherein the reversible peptide protease inhibitor has an affinity constant for the protease enzyme of from about 50 nM to about 2 uM; and/or the molar ratio of the reversible peptide protease inhibitor to the protease enzyme of from about 1: 1 to about 20: 1

In one embodiment the reversible peptide protease inhibitor is a tripeptide enzyme inhibitor. By tripeptide enzyme inhibitor, it is meant a compound that comprises three amino acids or their derivatives that may be substituted or unsubstituted. One illustrative tripeptide enzyme inhibitor has the formula:

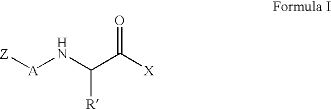

In Formula I, A is a diamino acid moiety, more specifically the diamino acid moiety is a combination of two amino acids selected from alanine (Ala), arginine (Arg), asparagine (Asn), aspartic acid (Asp), cysteine (Cys), glutamine (Gln), glutamic acid (Glu), glycine (Gly), histidine (His), homophenylalanine (HPhe), isoleucine (Ile), leucine (Leu), lysine (Lys), methionine (Met), phenyalanine (Phe), phenylglycine (PGly), proline (Pro), serine (Ser), threonine (Thr), tryptophan (Trp), tyrosine (Tyr) and valine (Val).

In one embodiment, A comprises two of alanine, glycine, leucine, valine, isoleucine, proline, lysine, phenylalanine, homophenylalanine, phenylglycine, tryptophan, glycine, arginine, methionine and combinations thereof, even more specifically still, valine and alanine.

The diamino acid moiety may be any suitable optical isomer, that is, the diamino acid moiety may be optically active in either the L or D configuration or combinations thereof, be optically inactive, or be a racemic mixture. Similarly, the individual amino acids that comprise the diamino acid moiety and/or the reversible peptide protease inhibitor may be optically active in either the L or D configuration or combinations thereof, or be optically inactive, or be a racemic mixture.

In Formula I, X is H, an electron withdrawing group and mixtures thereof. Non limiting examples of suitable electron withdrawing groups include, but are not limited to, CF₂H, CH₂F; CF₂—R CHF—R, CO₂—R, CH₂Cl, substituted or unsubstituted imidazoles, substituted or unsubstituted thioamidazoles, substituted or unsubstituted benzimidazoles, 15 and mixtures thereof, wherein R is selected from the group consisting of linear or branched, substituted or unsubstituted C₁-C₆ alkyl; and linear or branched substituted or unsubstituted C₄-C₈ cycloalkyl moieties; and mixtures thereof.

In Formula I, Z is a N-capping moiety selected from: 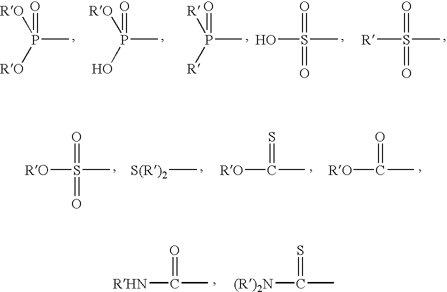 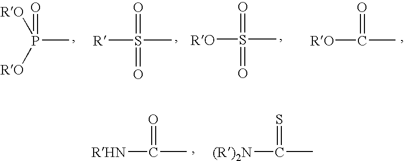
and mixtures thereof, more specifically, 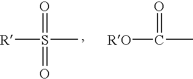
and mixtures thereof.

R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; and mixtures thereof, more specifically linear or branched, C₁-C₆ alkyl; phenyl; linear or branched, C₇-C₉ alkylaryl; and mixtures thereof, and even more specifically, linear or branched, C₁-C₆ alkyl; linear or branched substituted or unsubstituted C₅-C₉ alkylheterocyclic; and mixtures thereof.

Illustrative non-limiting examples of suitable tripeptide enzyme inhibitor include: 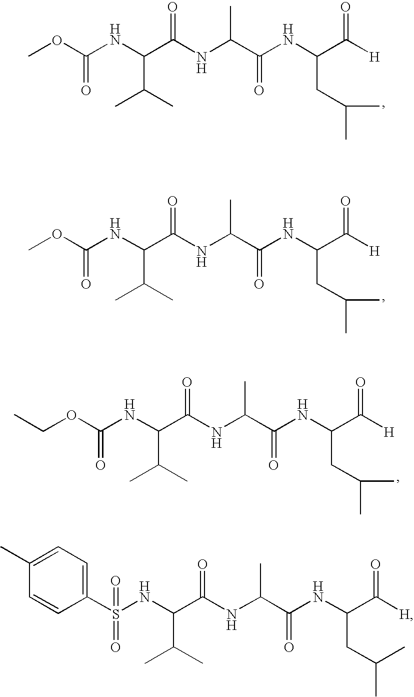 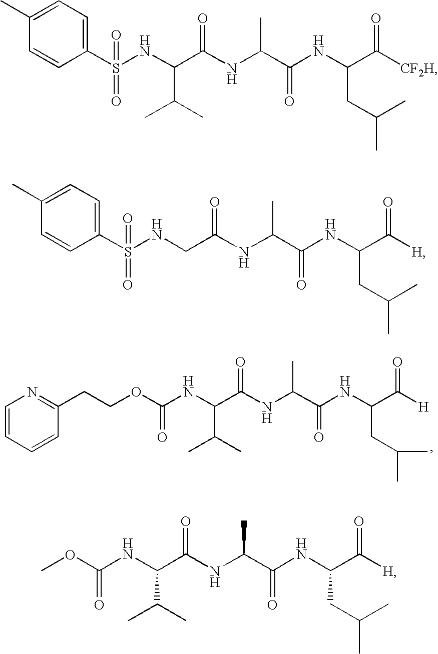
and mixtures thereof.

The reversible peptide protease inhibitor may be made in any suitable manner. Illustrative examples of suitable process for the manufacture of the reversible peptide protease inhibitor may be found in U.S. Pat. No. 6,165,966.

In one embodiment, the composition comprises from about 0.00001% to about 5%, specifically from about 0.00001% to about 3%, more specifically from about 0.00001% to about 1%, by weight of the composition, of the reversible peptide protease inhibitor.

Affinity constant—In one embodiment the reversible peptide protease inhibitor has an affinity constant for the protease enzyme of from about 50 nM to about 2 uM, specifically from about 100 nM to about 1 uM. The affinity constant of the inhibitor for the protease enzyme is the product of the free enzyme concentration and the free inhibitor concentration, divided by the concentration of the enzyme/inhibitor complex.

While not wishing to be limited by theory, it is believed that a reversible peptide protease inhibitor with an affinity constant of greater than about 2 uM has insufficient binding strength to bind to the protease and thereby prevent the protease from degrading itself or any other enzyme or present. Conversely, a reversible peptide protease inhibitor with an affinity constant of less than about 50 nM has too strong an affinity to the protease such that when the liquid detergent is diluted under typical wash conditions (i.e. when detergent is added to a laundry wash), the reversible peptide protease inhibitor will not release the protease sufficiently to deliver the required performance. It has now been surprisingly found that a reversible peptide protease inhibitor with an affinity constant between these ranges, namely from about 50 nM to about 2 uM, has sufficient strength to bind to a protease prior to use (thereby stabilizing the protease), and upon dilution (when the liquid composition is added to a typical wash solution), the protease enzyme is reactivated as the reversible peptide protease inhibitor diffuses away from the protease enzyme.

Determination of Affinity Constant of Reversible Peptide Inhibitor for a Protease Enzyme

The affinity constant of an inhibitor for a protease can be determined by mixing together a protease enzyme and reversible peptide protease inhibitor in a cuvette containing 1 ml of a 50 mM potassium phosphate pH 8 buffer at room temperature and pressure, i.e. 25° C. and 1 atmosphere. The protease enzyme is used at a concentration of 20 nM and the reversible peptide protease inhibitor at a concentration of 4.2 μM. (or 0 μM for the reference) The amount of active protease is measured upon addition of a substrate namely, succinyl-Ala-Ala-Pro-Phe-p-nitroaniline. The increase in optical density at 410 nm is measured over a six-second interval, beginning within fifteen seconds after the substrate is added, using a spectrophotometer such as a Beckman DU-70. Measurements are carried out at different substrate concentrations, namely 400, 200, 100, and 50 μg/ml. The results are plotted in a Lineweaver-Burk plot, with the inverse of the reaction rate plotted against the inverse of the substrate concentration. The slope is determined and compared to the slope of a similar plot of a control experiments carried out in the absence of inhibitor. The ratio of the slope in the presence of inhibitor to the slope in the absence of reversible peptide protease inhibitor is equal to (1+[I]/Ki) where [I] is the inhibitor concentration and Ki is the affinity constant for the inhibitor and protease.

Molar ratio—In an alternative embodiment, the reversible peptide protease inhibitor and protease enzyme are present in the liquid detergent compositions at a molar ratio of from about 1:1 to about 20:1, specifically from about 1:1 to about 10:1.

Protease Enzyme—The compositions and methods of the present invention comprise one or more protease enzymes. In one embodiment, the compositions and methods of the present invention include a protease enzyme from about 0.0001% to about 5%, specifically from about 0.001% to about 2%, more specifically from about 0.001% to about 1%, even more specifically from about 0.001% to about 0.2%, even more specifically still from about 0.005% to about 0.1%, by weight of the detergent composition, of a protease enzyme.

Any protease suitable for use in detergents can be used. Such proteases can be of animal, vegetable or microbial origin, with both modified (chemical or genetically variants) and unmodified proteases included.

One class of suitable proteases are the so-called serine endopeptidases [E.C. 3.4.21] and an example of which are the serine protease [E.C. 3.4.21.62]. Illustrative non-limiting examples of serine proteases includes subtilisins, e.g. subtilisins derived from Bacillus (e.g. B. subtilis, B. lentus, B. licheniformis, B. amyloliquefaciens, B. alcalophilus), for example, subtilisins BPN and BPN′, subtilisin Carlsberg, subtilisin 309, subtilisin 147, subtilisin 168, subtilisin PB92, their mutants and mixtures thereof.

Illustrative non-limiting examples of commercially available serine proteases, include, Alcalase®, Savinase®, Kannase®, Everlase® available from Novozymes; Purafect®, Purastar OxAm®, Properase® available from Genencor; BLAP and BLAP variants available from Henkel; and K-16-like proteases available from KAO. Additional illustrative proteases are described in e.g. EP130756, WO91/06637, WO95/10591, WO99/20726, U.S. Pat. No. 5,030,378 (Protease “A”) and EP251446 (Protease “B”).

Organic Polyol Solvents—In one embodiment, the liquid detergent composition and methods of the present invention may comprise less than about 5%, by weight of the detergent composition, specifically less than about 3%, by weight of the detergent composition, more specifically still less than about 1%, by weight of the detergent composition, even more specifically is substantially free of organic polyol solvents. By “substantially free of organic polyol solvents” it is meant that more specifically no organic polyol solvents are purposefully added to the formulation, but yet it is understood to one of ordinary skill in the art that trace amounts of organic polyol solvents may be present as impurities or as process/stability aids in other additives, i.e. the composition contain less than about 0.1%, by weight of the composition of organic polyol solvents.

By “organic polyol solvents”, it is meant low molecular weight organic solvents composed of carbon, oxygen and hydrogen atoms, and comprising 2 or more hydroxyl groups, such as ethanediol, 1,2 and 1,3 propanediol, glycerol, glycols and glycolethers, sorbitol, mannitol, 1,2 benzenediol, and mixtures thereof. This definition especially encompasses the diols, especially the vicinal diols that are capable of forming complexes with boric acid and borate to form borate esters.

These organic polyol solvents have in the past been used in combination with boric acid derivates as a protease enzyme stabilization system. The selection of a reversible peptide protease inhibitor with an affinity constant for the protease enzyme of from about 50 nM to about 2 uM, means that the use of these organic polyol solvents can be reduced, thereby saving money and time.

Boric acid derivatives—In another embodiment, the compositions and methods of the present invention, may comprise less than about 5%, by weight of the detergent composition, specifically less than about 3%, by weight of the detergent composition, more specifically less than about 1%, by weight of the detergent composition, even more specifically is substantially free of boric acid derivatives. By “substantially free of boric acid derivatives” it is meant that more specifically no boric acid derivatives are purposefully added to the formulation, but yet it is understood to one of ordinary skill in the art that trace amounts of boric acid derivatives may be present as impurities or as process/stability in other additives, i.e. the composition contain less than about 0.1%, by weight of the composition of boric acid derivatives.

By “boric acid derivatives” it is meant boron containing compounds such as boric acid per se, substituted boric acids and other boric acid derivatives that at least a part of which are present in solution as boric acid or a chemical equivalent thereof, such as a substituted boric acid. Illustrative, but non-limiting examples of boric acid derivatives includes, boric acid, boric oxide, borax, alkali metal borates (such as sodium ortho-, meta- and pyroborate and sodium pentaborate), and mixtures thereof.

As noted herein, these boric acid derivatives have in the past been used in combination with organic polyol solvents as a protease enzyme stabilization system. The selection of a reversible peptide protease inhibitor with an affinity constant for the protease enzyme of from about 50 nM to about 2 uM, means that the use of these boric acid derivatives can be reduced, thereby saving money and time.

Surfactants—In one embodiment the liquid detergent composition of the present invention may contain one or more surface active agents (surfactants). The surfactant may be selected from anionic, nonionic, cationic, amphoteric, zwitterionic and mixtures thereof. In one embodiment, surfactant detergents for use in the present invention are mixtures of anionic and nonionic surfactants although it is to be understood that any surfactant may be used alone or in combination with any other surfactant or surfactants. When present in the concentrated detergent composition, the surfactant may comprise, from about 0.1% to about 70%, more specifically from about 1% to about 50%, by weight of the liquid detergent composition.

Illustrative examples of surfactants useful herein are described in U.S. Pat. No. 3,664,961, U.S. Pat. No. 3,919,678, U.S. Pat. No. 4,062,647, U.S. Pat. No. 4,316,812 U.S. Pat. No. 3,630,929, U.S. Pat. No. 4,222,905, U.S. Pat. No. 4,239,659, U.S. Pat. No. 4,497,718; U.S. Pat. No. 4,285,841, U.S. Pat. No. 4,284,532, U.S. Pat. No. 3,919,678, U.S. Pat. No. 2,220,099 and U.S. Pat. No. 2,477,383. Surfactants generally are well known, being described in more detail in Kirk Othmer's Encyclopedia of Chemical Technology, 3rd Ed., Vol. 22, pp. 360-379, “Surfactants and Detersive Systems”, McCutcheon's, Detergents & Emulsifiers, by M.C. Publishing Co., (North American edition 1997), Schwartz, et al., Surface Active Agents, Their Chemistry and Technology, New York: Interscience Publishers, 1949; and further information and examples are given in “Surface Active Agents and Detergents” (Vol. I and II by Schwartz, Perry and Berch).

Nonionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable nonionic surfactants include: alcohol ethoxylates (e.g. Neodol 25-9 from Shell Chemical Co.), alkyl phenol ethoxylates (e.g. Tergitol NP-9 from Union Carbide Corp.), alkylpolyglucosides (e.g. Glucapon 600CS from Henkel Corp. ), polyoxyethylenated polyoxypropylene glycols (e.g. Pluronic L-65 from BASF Corp.), sorbitol esters (e.g. Emsorb 2515 from Henkel Corp.), polyoxyethylenated sorbitol esters (e.g. Emsorb 6900 from Henkel Corp.), alkanolamides (e.g. Alkamide DC212/SE from Rhone-Poulenc Co.), and N-alkypyrrolidones (e.g. Surfadone LP-100 from ISP Technologies Inc.); and combinations thereof.

Anionic surfactant, when present in the liquid detergent composition may be present in the amount of from about 0.01% to about 70%, more specifically from about 1% to about 50%, even more specifically from about 5% to about 40%, by weight of the liquid detergent composition. Illustrative examples of suitable anionic surfactants includes: linear alkyl benzene sulfonates (e.g. Vista C-500 commercially available from Vista Chemical Co.), branched linear alkyl benzene sulfonates (e.g. MLAS), alkyl sulfates (e.g. Polystep B-5 commercially available from Stepan Co.), branched alkyl sulfates, polyoxyethylenated alkyl sulfates (e.g. Standapol ES-3 commercially available from Stepan Co.), alpha olefin sulfonates (e.g. Witconate AOS commercially available from Witco Corp.), alpha sulfo methyl esters (e.g. Alpha-Step MCp-48 commercially available from Stepan Co.) and isethionates (e.g. Jordapon Cl commercially available from PPG Industries Inc.), and combinations thereof.

Cationic surfactant, when present in the liquid detergent composition, may be present in the amount of from about 0.01% to about 70%, more specifically from about 1% to about 50%, even more specifically from about 5% to about 40%, by weight of the liquid detergent composition. Specific cationic surfactants include C8-C 18 alkyl dimethyl ammonium halides and analogs in which one or two hydroxyethyl moieties replace one or two methyl moieties.

Amphoteric surfactant, when present in the liquid detergent composition may be present in the amount of from about 0.01% to about 70%, more specifically from about 1% to about 50%, even more specifically from about 5% to about 40%, by weight of the liquid detergent composition. Examples of amphoteric surfactants are sodium 3(dodecylamino)propionate, sodium 3-(dodecylamino)propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine.

Zwitterionic surfactant, when present in the liquid detergent composition may be present in the amount of from about 0.01% to about 70%, more specifically from about 1% to about 50%, even more specifically from about 5% to about 40%, by weight of the liquid detergent composition.

Non-Protease Enzyme—The compositions and methods of the present invention may include a non-protease enzyme, specifically from about 0.00001% to about 2%, more specifically from about 0.0005% to about 1%, even more specifically from about 0.001% to about 0.5%, by weight of the detergent composition, of a non-protease enzyme.

Non-protease enzymes can be included in effective amounts in the liquid laundry cleaning composition herein for a wide variety of fabric laundering purposes, including removal of protein-based, carbohydrate-based, or triglyceride-based stains, for example and/or for fabric restoration.

Examples of suitable non-protease enzymes include, but are not limited to, hemicellulases, peroxidases, cellulases, xylanases, lipases, phospholipases, esterases, cutinases, pectinases, pectate lyases, keratanases, reductases, oxidases, phenoloxidases, lipoxygenases, ligninases, pullulanases, tannases, pentosanases, malanases, mannanases, β-glucanases, arabinosidases, hyaluronidase, chondroitinase, laccases, amylases and combinations thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on.

A potential enzyme combination, in addition to protease, comprises a mixture of conventional detersive enzymes like lipase, cutinase, cellulases and/or amylase. Another optional potential enzyme is selected from cellulases, lipases, amylases, mannanases, pectate lyases and mixtures thereof. Detersive enzymes are described in greater detail in U.S. Pat. No. 6,579,839 and WO01/02530.

A non-limiting list of suitable commercially available non-protease enzymes include: Amylases (α and/or β) are described in WO 94/02597 and WO 96/23873. Commercial examples are Purafect Ox Am® [Genencor] and Termamyl®, Natalase®, Ban ®, Fungamyl® and Duramyl® [all ex Novozymes]. Cellulases include bacterial or fungal cellulases, e.g. produced by Humicola insolens, particularly DSM 1800, e.g. 50 Kda and ˜43 kD [Carezyme®]. Also suitable cellulases are the EGIII cellulases from Trichoderma longibrachiatum. Suitable lipases include those produced by Pseudomonas and Chromobacter groups. Preferred are e.g. Lipolase®, Lipolase Ultra®, Lipoprime® and Lipex® from Novozymes. Also suitable are cutinases [EC 3.1.1.50] and esterases. Also suitable are carbohydrases e.g. mannanase (U.S. Pat. No. 6,060,299), pectate lyase (WO99/27083) cyclomaltodextringlucanotransferase (WO96/33267) xyloglucanase (WO99/02663). Bleaching enzymes include e.g. peroxidases, laccases, oxygenases, (e.g. catechol 1,2 dioxygenase, lipoxygenase (WO 95/26393), (non-heme) haloperoxidases .

Adjunct Ingredients—The compositions and methods of the present invention may include an adjunct ingredient, specifically from about 0.0001% to about 95%, more specifically from about 0.001% to about 70%, by weight of the detergent composition, of an adjunct ingredient.

In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers, enzymes, soil suspending agents, anti-redeposition agents, deflocculating polymers, bactericides, fungicides, UV absorbers, anti-yellowing agents, anti-oxidants, optical brighteners, suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. Further examples of suitable adjunct ingredient and levels of use are described in U.S. Pat. No. 3,936,537, issued Feb. 3, 1976 to Baskerville, Jr. et al.; U.S. Pat. No. 4,285,841, Barrat et al., issued Aug. 25, 1981; U.S. Pat. No. 4,844,824 Mermelstein et al., issued Jul. 4, 1989; U.S. Pat. No. 4,663,071, Bush et al.; U.S. Pat. No. 4,909,953, Sadlowski, et al. issued Mar. 20, 1990; U.S. Pat. No. 3,933,672, issued Jan. 20, 1976 to Bartoletta et al.; U.S. Pat. No. 4,136,045, issued Jan. 23, 1979 to Gault et al; U.S. Pat. No. 2,379,942; U.S. Pat. No. 3,308,067; U.S. Pat. No. 5,147,576 to Montague et al; British Pat. No. 1,470,250; British Patent No. 401,413 to Marriott; British Patent No. 461,221 to Marriott and Guam British Patent No. 1,429,143; and U.S. Pat. No. 4,762,645, Tucker et al, issued Aug. 9, 1988.)

Non-limiting examples of some of possible adjunct ingredients follows.

Exemplary bleaching additives include bleaches such as hydrogen peroxide, perborate, percarbonate or peroxyacids such as 6-phthalimidoperoxyhexanoic acid and mixtures thereof.

Suitable chelants include, S,S-ethylenediamine disuccinic acid (EDDS), Tiron® (otherwise know as Catechol-2,5-disulfonate as the acid or water soluble salt), ethylenediamine tetraacetic acid (EDTA), Diethylenetriaminepentaacetate (DTPA), 1-Hydroxyethylidene 1,1 diphosphonic acid (HEDP), Diethylenetriamine-penta-methylene phosphonic acid (DTPMP), dipicolinic acid and salts and/or acids thereof and mixtures thereof. Further examples of suitable chelating agents and levels of use are described in U.S. Pat. Nos. 3,812,044; 4,704,233; 5,292,446; 5,445,747; 5,531,915; 5,545,352; 5,576,282; 5,641,739; 5,703,031; 5,705,464; 5,710,115; 5,710,115; 5,712,242; 5,721,205; 5,728,671; 5,747,440; 5,780,419; 5,879,409; 5,929,010; 5,929,018; 5,958,866; 5,965,514; 5,972,038; 6,172,021; and 6,503,876.

Examples of suitable builders which may be used include water-soluble alkali metal phosphates, polyphosphates, borates, silicates and also carbonates; water-soluble amino polycarboxylates; fatty acid soaps; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, silicates, and carbonates; water-soluble salts of mellitic acid, citric acid, and carboxymethyloxysuccinic acid, salts of polymers of itaconic acid and maleic acid, tartrate monosuccinate, tartrate disuccinate; and mixtures thereof.

Another optional adjunct ingredient is a thickener. Illustrative examples of thickeners include rheology modifiers, structurants and combinations thereof. Illustrative examples of structurants useful herein include methylcellulose, hydroxypropylmethylcellulose such as Methocel® trade name from Dow Chemical, xanthan gum, gellan gum, guar gum and hydroxypropyl guar gum, succinoglycan and trihydroxystearin. Other illustrative examples of structurants includes the nonpolymeric hydroxyfunctional structurants. A structurant is incorporated into a composition to establish desired rheological characteristics in a liquid product. When present these optional adjuncts are present in the compositions they are present at levels to provide the desired characteristics, specifically from about 0.01% to about 1% by weight, more specifically from about 0.015% to about 0.75% by weight, even more specifically from 0.02% to 0.5% by weight, of the compositions herein.

The nonpolymeric hydroxyfunctional structurant is selected from non-polymeric, crystalline hydroxy-functional materials which can form thread-like structuring systems throughout the liquid matrix when they are crystallized within the matrix in situ. Such materials can be generally characterized as crystalline, hydroxyl-containing fatty acids, fatty esters or fatty waxes. Specific illustrative and non-limiting examples of hydroxyl-containing structurants include castor oil and its derivatives. More specifically hydrogenated castor oil derivatives such as hydrogenated castor oil and hydrogenated castor wax. Commercially available, castor oil-based, crystalline, hydroxyl-containing structurants include THIXCIN® from Rheox, Inc. See also U.S. Pat. No. 6,080,708 and PCT Publication No. WO 02/40627. Another commercially available structurant is 1,4-di-O-benzyl-D-Threitol in the R,R, and S,S forms and any mixtures, optically active or not.

The detergent compositions herein may also optionally contain low levels of materials which serve as phase stabilizers and/or co-solvents for the liquid compositions herein. Materials of this type include C₁-C₃ lower alkanols such as methanol, ethanol and/or propanol. Lower C₁-C₃ alkanolamines such as mono-, di- and triethanolamines can also be used, by themselves or in combination with the lower alkanols. If present, phase stabilizers/co-solvents can optionally comprise from about 0.1% to about 5.0% by weight of the compositions herein.

Liquid Carrier—The liquid cleaning compositions according to the present invention may also contain a liquid carrier. Typically the amount of the liquid carrier when present in the compositions herein will be relatively large, often comprising the balance of the cleaning composition, but can comprise from about 5 wt % to about 85 wt % by weight of the cleaning composition. In one embodiment low levels, 5% to 20% by weight of the cleaning composition of liquid carrier is utilized.

In another embodiment, the compositions may comprise at least about 60%, more specifically at least about 65%, even more specifically at least about 70%, even more still at least about 75%, by weight of the cleaning composition of liquid carrier.

The most cost effective type of aqueous, non-surface active liquid carrier is, of course, water itself. In one embodiment, the water when present is selected from distilled, deionized, filtered and combinations thereof. In another embodiment, of the water may be untreated.

Optional Additional Enzyme Stabilizer—In an optional embodiment, optional additional enzyme stabilizers may be included. These optional additional enzyme stabilizers include those known enzyme stabilizers other than the reversible peptide protease inhibitor described herein. Illustrative examples of these additional optional enzyme stabilizers include any known stabilizer system like calcium and/or magnesium compounds, low molecular weight carboxylates, relatively hydrophobic organic compounds (i.e., certain esters, dialkyl glycol ethers, alcohols or alcohol alkoxylates), alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compounds, polyamide oligomer, glycolic acid or its salts; polyhexa methylene bi guanide or N,N-bis-3-amino-propyl-dodecyl amine or salt; and mixtures thereof. See also U.S. Pat. No. 3,600,319, Gedge, et al., EP 0 199 405 A, Venegas, U.S. Pat. No. 3,519,570

Liquid Detergent Composition Formulation—Liquid detergent compositions can be prepared by admixing the essential and optional ingredients thereof in any desired order to provide compositions containing components in the requisite concentrations. Liquid compositions according to the present invention can also be in “compact form”, in such case, the liquid detergent compositions according to the present invention will contain a lower amount of water, compared to conventional liquid detergents.

The reversible peptide protease inhibitor and protease enzyme can be added separately in the liquid detergent composition, or can be premixed with each other before addition to the liquid detergent composition.

The liquid detergent compositions may be of any desired color or appearance, namely opaque, translucent, or transparent, such as the compositions of U.S. Pat. No. 6,630,437 to Murphy et al., issued Oct. 7, 2003. For purposes of the invention, as long as one wavelength in the visible light range has greater than 25% transmittance, it is considered to be transparent or translucent.

The compositions according to the present invention may have any suitable pH, specifically a pH of from about 5.5 to about 11, more specifically from about 6 to about 9, even more specifically from about pH from about 6 to about 8.5. The composition pH is measured as a neat solution at standard temperature and pressure, i.e. 21° C., and at 1 atmosphere pressure.

Detergent Packaging—The detergent compositions according to the present invention may be presented to the consumer in standard packaging, or may be presented in any suitable packaging. Recently, multiple compartment bottles containing multiple formulations that are dispensed and combined have become used for detergent compositions. The compositions of the present invention may be formulated for inclusion in such packages. In addition, unit dose packages have also become commonly used for detergent compositions. Such packages are also suitable for use with the compositions of the present invention. The packaging may be of any desired color or appearance, namely opaque, translucent, transparent, or even combinations thereof. Illustrative but nonlimiting packages may be found in U.S. Pat. No 6,630,437 to Murphy et al., issued Oct. 7, 2003.

Methods of Use—The present invention also provides a method for cleaning fabrics. Such a method employs contacting these fabrics with an aqueous washing solution formed from an effective amount of the liquid detergent compositions hereinbefore described. Contacting of fabrics with washing solution will generally occur under conditions of agitation.

Agitation is typically provided in a washing machine for good cleaning. Washing is typically followed by drying the wet fabric, such as in a conventional clothes dryer, by hanging on an outside clothes line, indoor drying rack, or the like. An effective amount of the liquid detergent composition in the aqueous wash solution in the washing machine may be specifically from about 500 to about 10,000 ppm, more specifically from about 2,000 to about 10,000 ppm, under typical European washing conditions and may be specifically from about 1,000 to about 3,000 ppm under typical U.S.A. washing conditions. In the newer high efficiency (HE) washing machines in the U.S.A., higher product concentrations are delivered to fabric and therefore soil and dye-loads in the wash solution are even higher. Product concentration and raw material levels are thereby adjusted to accommodate these changes in wash conditions due to washing machine changes.

Antibacterial Stabilization—It has now been surprisingly found that the reversible peptide protease inhibitors of the present invention may also be used to stabilize liquid compositions, specifically liquid detergent compositions against microbial attack. Specifically the reversible peptide protease inhibitors at least inhibits the growth of at least one microbiological flora or fauna (also known as microbiological organisms) in the liquid detergent, specifically at least inhibits the contamination of the liquid detergent by at least one microbiological flora or fauna, more specifically prevents the growth of at least one microbiological flora or fauna in the liquid detergent. In one embodiment the reversible peptide protease inhibitors at least inhibits the growth of at least one bacteria in the liquid detergent, specifically at least inhibits the contamination of the liquid detergent by at least one bacteria, more specifically prevents the growth of at least one bacteria in the liquid detergent. In another embodiment the reversible peptide protease inhibitors at least inhibits the growth of at least one Gram negative bacteria in the liquid detergent, specifically at least inhibits the contamination of the liquid detergent by at least one Gram negative bacteria, more specifically prevents the growth of at least one Gram negative bacteria in said liquid detergent, more specifically still a 2 log reduction of Gram negative bacteria in the liquid detergent, even more specifically still a 3 log reduction of gram negative bacteria in the liquid detergent. By “inhibit” it is meant that the total population of at least one microbiological flora or fauna, specifically bacteria, more specifically Gram negative bacteria remains approximately the same, or static. By “microbiological flora or fauna” it is meant microbial life, such as, mould, fungus, bacteria (both Gram negative and Gram positive), viruses, microbes, prions, and the like.

This microbial contamination may arise from various sources during manufacturing, such as, air-borne contaminants, handling and cross-contamination events and the like. During consumer use, the liquid detergent may become potentially contaminated from various sources, such as, air-borne sources, handling and cross-contamination events and the like.

The reversible peptide protease inhibitors provide at least an inhibition of at least one of these microbial contaminants in the liquid detergent, thereby preserving the liquid detergent. This surprising benefit means potentially that the amount of conventional microbial preservatives can be reduced or potentially even eliminated, thereby reducing the costs associated with the production and sale of the liquid detergent.

Illustrative non-limiting examples of Gram negative bacteria includes Pseudomonas, such as, Pseudomonas aeruginosa, and Pseudomonas fluorescens; Burkholderia, such as Burkholderia Pseudomona cepacia; Klebsiella, such as Klebsiella oxytoca; Serratia, Escherichia, such as Escherichia coli; or similar environmentally sourced species, such as Citrobacter freundii and Serratia liquefaciens.

To determine if a compound is capable of at least inhibiting the growth of at least one Gram negative bacteria in the liquid detergent the following test is performed.

A mixture of Gram negative bacteria, also known as a Gram negative cocktail or cocktail, is prepared. The Gram negative cocktail comprises a mixture of Pseudomonas aeruginosa ATCC 9027, Pseudomonas fluorescens ATCC 13525, Burkholderia (Pseudomonas) cepacia ATCC 25416, Klebsiella oxytoca ATCC 13182, Escherichia coli ATCC 8739, Citrobacter freundii ATCC 8090 and Serratia liquefaciens ATCC 27592. The Gram negative bacterial cocktail is prepared by growing each organism individually on plates containing a growth medium and picking isolated colonies for preparation of the Gram negative cocktail. The growth medium is TSA (tryptic soy agar, available from Becton Dickinson). TSA contains per liter water: 15 g pancreatic digest of casein, 5 g enzymatic digest of soy bean meal, 5 g sodium chloride, and 15 g agar with the pH adjusted to 7.3±0.2 using hydrochloric acid, HCL (J. T. Baker).

The individually selected colonies are added to sterilized saline and adjusted to a McFarland standard of #2 (Available from bioMerieux, Inc.) to prepare a standardized saline suspension for the organism. This is repeated for each organism individually, thereby by preparing a standardized saline suspension for each organism. An equal volume (1 ml) of each standardized saline suspension of the following cocktail members are mixed together: Pseudomonas aeruginosa ATCC 9027, Pseudomonas fluorescens ATCC 13525, Burkholderia (Pseudomonas) cepacia ATCC 25416, Klebsiella oxytoca ATCC 13182, Escherichia coli ATCC 8739, Citrobacter freundii ATCC 8090 and Serratia liquefaciens ATCC 27592.

An inoculated liquid laundry detergent is prepared by the addition to 49.5 ml of the standard liquid laundry detergent, described in Table A below, of 0.5 ml of the Gram negative bacterial cocktail as prepared above. This standard liquid laundry detergent also contains from about 0.00001% to about 5%, by weight of the composition, of one or more of the tripeptide enzyme inhibitors described herein.

TABLE A

| | Standard Liquid |
|---|---|
| | Laundry Detergent |
| C₁₂₋₁₅ alkyl ethoxy (EO_{1.8}) sulfate | 7.07 |
| C₁₂₋₁₆ ethoxylated (EO₉) alcohol | 0.40 |
| Branched alkyl sulfate | 6.87 |
| C₁₂₋₁₈ Fatty Acid | 0.954 |
| Citric Acid | 1.758 |
| Diethylene triamine penta acetic acid | 0.458 |
| Ethoxylated Polyethyleneimine¹ | 0.625 |
| Ethanol | 1.094 |
| 1,2-Propanediol | 4.71 |
| Sodium formate | 0.466 |
| Calcium formate | 0.0637 |
| Monoethanolamine | 1.15 |
| Sodium hydroxide, sufficient to | 8.2 |
| adjust to pH | |
| Water + Minors (perfume, etc) | Quantity Sufficient |
| | (q.s.) to 100% |

¹Lutensol FP620 from BASF

As the cocktail contains approximately 10⁷ to 10⁸ cfu/ml (colony forming units/ml); the resulting inoculum level in the inoculated liquid laundry detergent is 10⁵ to 10⁶ cfu/ml. The inoculated liquid laundry detergent is stored at 35° C., a relative humidity of about 60% and at standard pressure, i.e. 1 atmosphere. Samples of Iml are removed from the inoculated liquid laundry detergent at the following times, 1 day, 2 days, 7 days, 14 days, 21 days and 28 days. These 1 ml samples, are immediately neutralized by addition to a neutralizer, namely polyvalent universal neutralizer (PVUN) which contains (per liter distilled water): 30 g Polysorbate 80 (Available under the brand Tween 80, from VWR International), 5 g Sodium thiosulfate, Ig L-Histidine, Ig Peptone, 8.5 g Sodium chloride, 14.3 g Lecithin with the pH adjusted to 7.0±0.2 with HCL.

Each neutralized sample is then subjected to a serial dilution, to the 10⁻⁵ dilution to allow full enumeration of the surviving microbial population. For example, 1 ml of sample is added to 9 ml of PVUN, resulting in a 1:10 dilution, or 10⁻¹ dilution. A 1 ml sample of this 1:10 dilution is then added to another 9 ml PVUN, resulting in a 1:100 dilution, or 10⁻² dilution, and so on. Serial dilutions are carried out to 10⁻⁵. 1.0 ml of the various dilutions (10⁻¹ or 10⁻⁵) are then either spread or pour plated on TSA (tryptic soy agar, Becton Dickinson) and are then incubated for 72 hours at 35° C.±2° C.

After incubation, the plates are counted and recorded as cfu/ml survival vs. time (days 1, 2, 7, 14, 21, and 28 days). Results are recorded as log viable cells on specified sampling days. If the microbial population of at least one Gram negative bacteria in the inoculated liquid laundry detergent is held approximately static, i.e. no increase vs. the original inoculation then the tripeptide enzyme inhibitor has at least inhibited the growth of at least one gram negative bacteria in liquid laundry detergents. Alternatively, if the microbial population of at least one Gram negative bacteria of the inoculated liquid laundry detergent is reduced, i.e. a decrease vs. the original inoculation then the tripeptide enzyme inhibitor prevents the growth of at least one Gram negative bacteria in liquid laundry detergents.

The following results may be obtained for the tripeptide enzyme inhibitor of the formula:

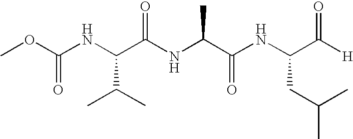

This tripeptide enzyme inhibitor is added to the standard liquid laundry detergent in an amount of 0.004% by weight of the composition. The results of this test would show that the tripeptide enzyme inhibitor prevents the growth of Gram negative bacteria in liquid laundry detergents.

| | Day 1 | Day 2 | Day 7 | Day 14 | Day 21 | Day 28 |
|---|---|---|---|---|---|---|
| Count | 4.7 | 4.0 | <0.1 | <0.1 | <0.1 | <0.1 |

The same experiment can be made using the individual strains instead of the cocktail to evaluate the inhibition of each individual strain.

### EXAMPLES

The following liquid detergent compositions in table 1 are prepared and put in storage for 3 weeks at 30° C. The stability of the protease is then determined. Example B is a composition that is illustrative of the present composition and methods. Example B shows significantly improved protease stability vs. comparative example A.

TABLE 1

| | A(Comparative) | B |
|---|---|---|
| C₁₁₋₁₂ linear alkyl benzene sulfonate | 8 | 8 |
| C₁₄₋₁₅ ethoxylated (EO₈) alcohol | 6 | 6 |
| C₁₂₋₁₄ dimethyl Amine Oxide | 1 | 1 |
| C₁₂₋₁₈ Fatty Acid | 5 | 5 |
| Citric Acid | 2 | 2 |
| Diethylene triamine penta methylenephosphonic acid | 0.2 | 0.2 |
| Ethoxysulfated hexamethylene diamine quat¹ | 0.8 | 0.8 |
| Ethoxylated Polyethyleneimine² | 0.2 | 0.2 |
| Ethoxylated tetraethylene pentamine³ | 0.2 | 0.2 |
| Ethanol | 1.4 | 1.4 |
| 1,2-Propanediol | 4.9 | 4.9 |
| Na Cumene Sulfonate | 0.8 | 0.8 |
| Monoethanolamine | 0.5 | 0.5 |
| Protease⁴ (40 mg/g) | 0.46 | 0.46 |
| Termamyl ® 300 L (Novozymes) | 0.05 | 0.05 |
| Natalase ® 200 L (Novozymes) | 0.07 | 0.07 |
| Mannanase ® 25 L (Novozymes) | 0.04 | 0.04 |
| Reversible Protease Inhibitor⁵ | — | 0.004 |
| Hydrogenated castor oil structurant | 0.2 | 0.2 |
| Sodium hydroxide, sufficient to adjust to pH | 8.2 | 8.2 |
| Water + Minors (perfume, etc) | q.s to 100% | q.s to 100% |
| Protease stability (% left after 3 weeks at 30° C.) | 35% | 88% |

¹Lutensit Z from BASF
²Lutensol FP620 from BASF
³Lutensol PG105K from BASF
⁴Protease “B” in EP251446.

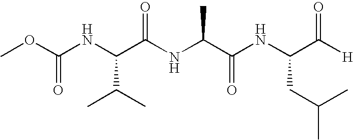

⁵Reversible Protease inhibitor of structure

Additional non-limiting illustrative examples of liquid detergents are given in Tables 2, 3 and 4.

TABLE 2

| | C | D | E | F | G |
|---|---|---|---|---|---|
| C₁₁₋₁₂ linear alkyl benzene sulfonic | 8 | 8 | 12 | 12 | 0.2 |
| acid | | | | | |
| C₁₄₋₁₅ ethoxylated (EO₈) alcohol | 5 | 5 | 8 | 8 | 11 |
| C₁₂₋₁₄ dimethyl Amine Oxide | 1 | 1 | — | — | 3 |
| C₁₂₋₁₈ Fatty Acid | 2.6 | 2.6 | 4 | 4 | — |
| Citric Acid | 2.6 | 2.6 | 4 | 4 | 3 |
| Diethylene triamine penta | 0.2 | 0.2 | 0.3 | 0.3 | 0.3 |
| methylenephosphonic acid | | | | | |
| Ethoxysulfated hexamethylene | 1.2 | 1.2 | 2 | 2 | 2 |
| diamine quat¹ | | | | | |
| Ethanol | 1.4 | 1.4 | 1.4 | 1.4 | 0.4 |
| 1,2-Propanediol | 2.4 | 2.4 | 2.4 | 2.4 | 3 |
| Diethylene glycol | 1.6 | 1.6 | 1.6 | 1.6 | — |
| 2-methyl-1,3-Propanediol | 1 | 1 | 1 | 1 | — |
| Na Cumene Sulfonate | 0.7 | 0.7 | 2 | 2 | — |
| Boric Acid | 0.5 | — | 1 | — | 0.3 |
| Sodium formate | 0.5 | — | — | — | — |
| Monoethanolamine | 0.5 | — | 0.8 | 0.8 | 0.7 |
| Protease² (40 mg/g) | — | 0.46 | 0.72 | — | 0.46 |
| Savinase ® 16 L (Novozymes) | 0.5 | — | — | 0.8 | — |
| Alcalase ® 2.5 L (Novozymes) | — | — | 0.6 | — | — |
| Termamyl ® 300 L (Novozymes) | 0.05 | 0.05 | 0.07 | 0.07 | — |
| Natalase ® 200 L (Novozymes) | 0.07 | 0.07 | 0.10 | 0.10 | 0.14 |
| Mannaway ® 25 L (Novozymes) | 0.04 | 0.04 | 0.06 | 0.06 | 0.04 |
| Pectawash ® 20 L (Novozymes) | 0.10 | 0.10 | 0.17 | 0.17 | — |
| Carezyme ® 5 L(Novozymes) | 0.002 | — | — | — | — |
| Reversible Protease Inhibitor³ | 0.002 | | | 0.004 | |
| Reversible Protease Inhibitor⁴ | | 0.004 | | | |
| Reversible Protease Inhibitor⁵ | | | 0.002 | | 0.002 |
| CaCl2 | — | — | — | — | 0.03 |
| Hydrogenated castor oil structurant | 0.2 | 0.2 | 0.4 | 0.4 | 0.5 |
| Cationic silicone⁶ | — | — | — | — | 1 |
| Sodium hydroxide, sufficient to | 8.2 | 8.2 | 8.2 | 8.2 | 8.2 |
| adjust to pH | | | | | |
| Water + Minors (perfume, etc) | q.s to | q.s to | q.s to | q.s to | q.s to |
| | 100% | 100% | 100% | 100% | 100% |

¹Lutensit Z from BASF
²Protease B in EP251446.
³Reversible Protease inhibitor of structure

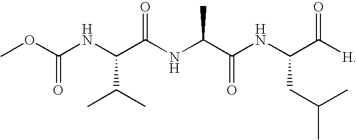

⁴Reversible Protease inhibitor of structure

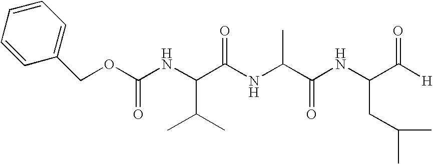

⁵Reversible Protease inhibitor of structure

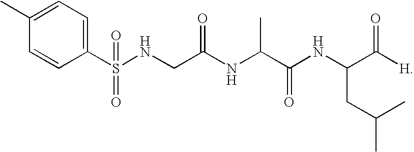

⁶Cationic silicone as per WO 2002/18528.

TABLE 3

| | H | I | J | K | L | M |
|---|---|---|---|---|---|---|
| C₁₁₋₁₂ linear alkyl benzene sulfonic acid | 23 | 6 | 7 | — | 8 | — |
| C₁₂₋₁₅ alkyl ethoxy (EO_{1.8}) sulfate | — | 12 | 7 | 18 | 3 | — |
| C₁₂₋₁₄ ethoxylated (EO₇) alcohol | 20 | — | — | — | 10 | 14 |
| C₁₂₋₁₃ ethoxylated (EO₉) alcohol | — | 1 | 4 | 0.5 | — | — |
| C12-14 Alkyl Poly Glycoside | — | — | — | — | — | 2 |
| C₁₂₋₁₄ Dimethyl Amine Oxide | — | 1 | — | — | — | 1.5 |
| C12 Tri Methyl Ammonium Chloride | — | — | — | 2.5 | — | — |
| C₁₂₋₁₈ Fatty Acid | 17 | 2 | 6 | 2.5 | 8 | — |
| Citric Acid | — | 3.5 | 2 | 2.5 | — | — |
| Tri sodium citrate | — | — | — | — | — | 0-20 |
| Diethylene triamine penta acetate MW = 393 | — | 0.1 | 0.3 | — | — | — |
| Ethoxysulfated hexamethylene diamine quat¹ | 1.2 | 1 | — | 0.5 | — | — |
| Ethoxylated Polyethyleneimine² | 1.6 | 1 | 2 | 0.5 | — | — |
| Ethoxylated tetraethylene pentamine³ | 1.6 | 0.5 | 1 | 0.3 | — | 2 |
| Maleic/Acrylic/hydrophobe terpolymer⁴ | — | — | — | — | — | 1-10 |
| Ethanol | — | 2 | 1.5 | 3 | — | 8 |
| 1,2-Propanediol | 22 | 7 | 5 | 5 | 4 | 10 |
| Sorbitol | — | — | — | — | 5 | |
| Na Cumene Sulfonate | — | — | — | 3 | — | 2 |
| Formic acid | — | — | — | — | — | 0.5 |
| Borax | — | 0.5 | 0.25 | 0.3 | — | — |
| Sodium silicate | — | — | — | — | 2 | — |
| Sodium formate | 0.5 | 0.15 | — | 0.03 | — | — |
| Monoethanolamine | 8 | 1.5 | 4 | 1.5 | — | 0-4 |
| Triethanolamine | — | — | — | — | 1 | — |
| Protease⁵ (40 mg/g) | 1.2 | 1 | 1 | 0.35 | 0.5 | 0.5 |
| Termamyl ® 300 L (Novozymes) | — | — | — | — | — | 0.5 |
| Natalase ® 200 L (Novozymes) | 0.14 | 0.3 | 0.11 | — | — | — |
| Mannaway ® 25 L (Novozymes) | 0.12 | 0.05 | 0.05 | — | — | — |
| Lipolase ® 100 L(Novozymes) | — | — | — | — | — | 0.5 |
| Quaternary amine⁶ | | | | | | 2 |
| Polymer LR400⁷ | — | — | — | — | 0.3 | — |
| Reversible Protease Inhibitor⁸ | 0.001 | — | — | — | 0.002 | — |
| Reversible Protease Inhibitor⁹ | — | — | 0.003 | 0.002 | — | — |
| Reversible Protease Inhibitor¹⁰ | — | — | — | — | — | 0.004 |
| Reversible Protease Inhibitor¹¹ | — | 0.002 | — | 0.002 | — | — |
| CaCl2 | — | 0.01 | 0.01 | — | — | 1 |
| Preservative | — | — | — | — | 0.01 | — |
| Sodium hydroxide. Sufficient to adjust | 8.2 | 8.0 | 8.0 | 8.2 | 8.2 | 8.2 |
| to pH | | | | | | |
| Water + Minors (perfume, etc) | q.s. to | q.s. to | q.s. to | q.s. to | q.s. to | q.s. to |
| | 100% | 100% | 100% | 100% | 100% | 100% |

¹Lutensit Z from BASF
²Lutensol FP620 from BASF
³Lutensol PG105K from BASF
⁴as per example 1 in U.S. Pat. No. 5,308,530.
⁵Protease “B” in EP251446.
⁶Arquad 2HT
⁷Cationic cellulose polymer available from Amerchol
⁸Reversible Protease inhibitor of structure

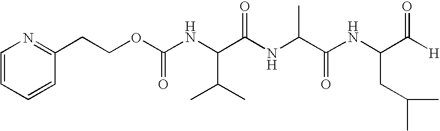

⁹Reversible Protease inhibitor of structure

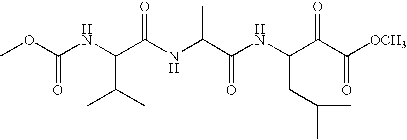

¹⁰Reversible Protease inhibitor of structure

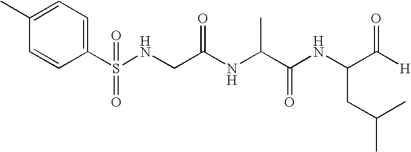

¹¹Reversible Protease inhibitor of structure

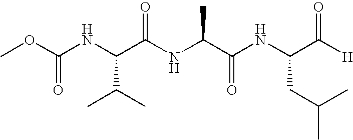

TABLE 4

| | N | O | P | Q |
|---|---|---|---|---|
| C₁₁₋₁₂ linear alkyl benzene sulfonic acid | 8 | 8 | 8 | — |
| C₁₂₋₁₅ alkyl ethoxy (EO₃) sulfate Na salt | — | — | — | — |
| C16-18 Alkyl Sulfate Na salt | — | — | — | 0.3 |
| C₁₄₋₁₅ ethoxylated (EO₈) alcohol | 7 | 7 | 7 | — |
| C₁₂₋₁₄ ethoxylated (EO₇) alcohol | | | | — |
| C₁₂₋₁₈ ethoxylated (EO₉)alcohol | — | — | — | 14 |
| C12-14 Alkyl Poly Glycosides | — | — | — | 1 |
| C8-10 Alkyl amidopropyl dimethylamine | — | — | — | — |
| Di C16-18 alkyl ethoxymethyl ammonium methosulfate | — | — | — | 1.6 |
| C₁₂₋₁₈ Fatty Acid | 2.6 | 2.6 | 2.6 | 0.5 |
| Citric Acid0 | 2.6 | 2.6 | 2.6 | — |
| Diethylene triamine penta methylenephosphonic acid | 0.2 | 0.2 | 0.2 | — |
| Ethoxysulfated hexamethylene diamine quat¹ | 2 | 2 | 2 | — |
| Ethoxylated Polyethyleneimine² | — | — | — | — |
| Ethoxylated tetraethylene pentamine³ | — | — | — | — |
| Ethanol | 2.5 | 2.5 | 2.5 | 0.5 |
| 1,2-Propanediol | 0.8 | 0.8 | 0.8 | — |
| isopropanol | — | — | — | 0.3 |
| Na Cumene Sulfonate | 0.5 | 0.5 | 0.5 | — |
| Boric acid | 0.5 | — | — | — |
| Sodium formate | — | — | — | — |
| Monoethanolamine | 0.5 | 0.5 | 0.5 | — |
| Sodium hydroxide, trim to pH | 8.2 | 8.2 | 8.2 | 6.5 |
| Protease⁴ (40 mg/g) | 0.46 | 0.46 | 0.46 | 0.5 |
| Termamyl ® 300 L (Novozymes) | 0.05 | 0.05 | 0.05 | — |
| Natalase ® 200 L (Novozymes) | 0.07 | 0.07 | 0.07 | — |
| Mannanase ® 25 L (Novozymes) | 0.04 | 0.04 | 0.04 | — |
| Pectawash ® 20 L (Novozymes) | 0.11 | 0.11 | 0.11 | — |
| Carezyme ® 5 L(Novozymes) | — | 0.01 | 0.01 | — |
| CaCl2 | — | — | — | — |
| Polymer LR400⁵ | — | — | — | |
| Reversible Protease Inhibitor⁶ | 0.002 | 0.004 | 0.004 | 0.004 |
| Hydrogenated castor oil structurant | 0.4 | 0.4 | — | — |
| Polyacrylate thickener (polygel W301) | — | — | — | — |
| Sodium hydroxide. Sufficient to adjust to pH | 8.2 | 8.0 | 8.0 | 8.2 |
| Water + Minors (perfume, etc) | q.s. to | q.s. to | q.s. to | q.s. to |
| | 100% | 100% | 100% | 100% |

¹Lutensit Z from BASF
²Lutensol FP620 from BASF
³Lutensol PG105K from BASF
⁴Protease “B” in EP251446.
⁵Cationic cellulose polymer available from Amerchol
⁶Reversible Protease inhibitor of structue

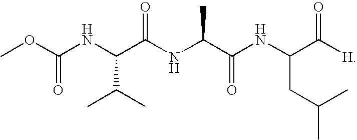

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

The compositions of the present invention can include, consist essentially of, or consist of, the components of the present invention as well as other ingredients described herein. As used herein, “consisting essentially of” means that the composition or component may include additional ingredients, but only if the additional ingredients do not materially alter the basic and novel characteristics of the claimed compositions or methods.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein. All temperatures are in degrees Celsius (° C.) unless otherwise specified.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid detergent composition comprising:
(a) a surfactant;
(b) a protease enzyme;
(c) a reversible peptide protease inhibitor, wherein said reversible peptide protease inhibitor is a tripeptide enzyme inhibitor;
(d) an adjunct ingredient;
wherein said liquid detergent composition further comprises at least one of:
(i) said reversible peptide protease inhibitor has an affinity constant for said protease enzyme of from about 50 nM to about 2 uM; and/or (ii) a molar ratio of said reversible peptide protease inhibitor to said protease enzyme of from about 1:1 to about 20:1.

2. The composition according to claim 1, wherein said tripeptide enzyme inhibitor has the formula: 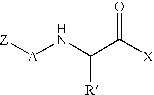
wherein A is a diamino acid moiety; X is H, an electron withdrawing group and mixtures thereof; and Z is a nitrogen capping moiety selected from: 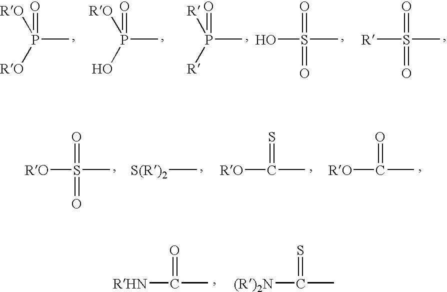
and mixtures thereof,
wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; linear or branched substituted or unsubstituted C₅-C₉ alkylheterocyclic; and mixtures thereof.

3. The composition according to claim 1, wherein said composition comprises less than about 3%, by weight of the composition, of boric acid derivatives.

4. The composition according to claim 1, wherein said composition is substantially free of boric acid derivatives.

5. The composition according to claim 1 wherein said protease enzyme is a serine protease.

6. The composition according to claim 1, wherein said composition comprises less than about 3%, by weight of the composition, of organic polyol solvents.

7. The composition according to claim 1, wherein said tripeptide enzyme inhibitor is selected from: 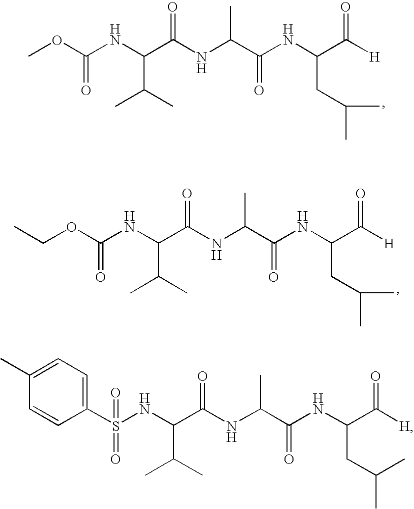 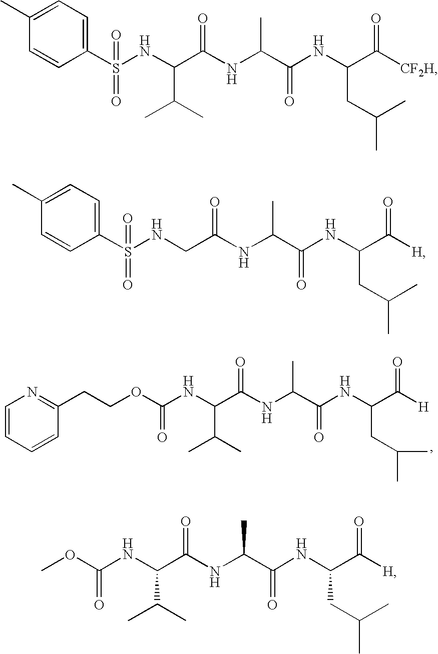
and mixtures thereof.

8. An article of commerce comprising
(a) a container; and
(b) a liquid laundry detergent according to claim 1 stored in said container.

9. The article of Commerce according to claim 8 wherein said container is transparent or translucent.

10. A method of stabilizing enzymes in a liquid detergent composition, wherein said liquid detergent composition comprises one or more protease enzymes and wherein said method comprises at least the step of adding a stabilizing effective amount of a reversible peptide protease inhibitor to said liquid detergent composition, wherein said reversible peptide protease inhibitor has the formula:

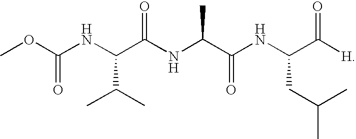

11. The method according to claim 10, wherein said liquid detergent composition comprises less than about 1%, by weight of the composition, of boric acid derivatives.

12. The method according to claim 10, wherein said composition is substantially free of organic polyol solvents.

13. The method according to claim 10, wherein said composition is a heavy duty detergent composition suitable for laundry care.

14. A liquid detergent composition comprising:
(a) a surfactant;
(b) a protease enzyme;
(c) a reversible peptide protease inhibitor, wherein said reversible peptide protease inhibitor is a tripeptide enzyme inhibitor; and
(d) an adjunct ingredient;
wherein said reversible peptide protease inhibitor at least inhibits the growth of at least one microbiological flora or fauna in said liquid detergent.

15. The composition according to claim 14, wherein said tripeptide enzyme inhibitor has the formula: 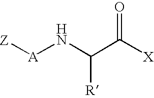
wherein A is a diamino acid moiety; X is H, an electron withdrawing group and mixtures thereof; and Z is a nitrogen capping moiety selected from: 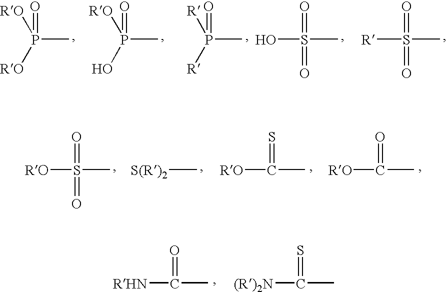
and mixtures thereof,
wherein each R′ is independently selected from linear or branched, substituted or unsubstituted C₁-C₆ alkyl; phenyl; linear or branched, substituted or unsubstituted C₇-C₉ alkylaryl; linear or branched substituted or unsubstituted C₄-C₈ cycloalkyl moieties; linear or branched substituted or unsubstituted C₅-C₉ alkylheterocyclic; and mixtures thereof.

16. The composition according to claim 14 wherein said reversible peptide protease inhibitor at least inhibits the contamination of said liquid detergent by at least one microbiological flora or fauna.

17. The composition according to claim 14 wherein said reversible peptide protease inhibitor prevents the growth of at least one microbiological flora or fauna in said liquid detergent.

18. The composition according to claim 14 wherein said reversible peptide protease inhibitor at least inhibits the growth of at least one gram negative bacteria in said liquid detergent by.

19. The composition according to claim 14 wherein said reversible peptide protease inhibitor at least inhibits the contamination of said liquid detergent by at least one gram negative bacteria.

20. The composition according to claim 14, wherein said reversible peptide protease inhibitor has the formula: [chemical structure]
